(19) United States
(12) Patent Application Publication
(10) Pub. No.: US 2025/0278656 A1
(43) Pub. Date: Sep. 4, 2025

(54) SYSTEM AND METHOD FOR USE IN GENERATIVE MODELS

(71) Applicants: Aarhus Universitet, Aarhus C (DK); Gottfried Wilhelm Leibniz Universität Hannover, Hannover (DE)

(72) Inventors: Thomas Bækkegaard, Aarhus C (DK); Nikolaj Thomas Zinner, Aarhus C (DK); Michael Kues, Hannover (DE); Anahita Khodadad Kashi, Hannover (DE)

(73) Assignees: Aarhus Universitet, Aarhus C (DK); Gottfried Wilhelm Leibniz Universität Hannover, Hannover (DE)

(21) Appl. No.: 18/866,699

(22) PCT Filed: Mar. 27, 2023
(86) PCT No.: PCT/EP2023/057834

§ 371 Date: Nov. 18, 2024

(30) Foreign Application Priority Data
May 20, 2022 (EP) 22174479.0

(51) Int. Cl. G06N 10/40; G06N 10/60

(52) U.S. Cl. CPC G06N 10/40; G06N 10/60

(57) ABSTRACT

Generative models, in particular quantum generative models, for example generative adversarial networks (GANs) and in particular quantum adversarial networks, may include a generator system comprising a quantum frequency comb system configured for generating sample data, and optionally a discriminator system for distinguishing the sample data from training data. The generative model may be implemented in quantum systems.

### CROSS-REFERENCE TO RELATED APPLICATIONS

The present application is the National Phase entry of International Patent Application No. PCT/EP2023/057834, filed Mar. 27, 2023, which claims priority to European Patent Application No. 22174479.0, filed May 20, 2022, the entire contents of both are hereby incorporated by reference into this application.

### TECHNICAL FIELD

The present disclosure relates to generative models, in particular quantum generative models, for example generative adversarial networks (GANs) and in particular quantum adversarial networks, and implementation of generative models in quantum systems.

### BACKGROUND

Classifier models can classify information based on different criteria. Common types of classifiers are generative models and discriminative models, wherein the generative models can generate information based on a set of rules and the discriminative models can distinguish different information based on a set of conditions. A generative model is typically a statistical model of the joint probability distribution on a collection of observables and a target variable. Thus, finding the right generative model makes it possible to sample from this probability distribution. The generated or discriminated information can have different structure and nature, include data in various formats, such as random numbers, missing elements in a set of given information, audio files or even images. In the recent decade, as machine learning has matured, neural networks have been added to the toolbox of generative models.

A powerful commonly used classifier is one which comprises a generative model generating a desired information and a discriminative model distinguishing the generated information from a set of initial information. A well-known example is Generative Adversarial Networks (GAN), where two neural networks “contest” with each other in a zero-sum “game”, where one agent's gain is another agent's loss. Provided with a training set, a GAN can learn to generate new data with the same structure and statistics as the training set. Generative adversarial networks have in the recent years proved as a powerful tool for generating incredibly realistic images: A GAN trained on photographs can generate new photographs that look at least superficially authentic to human observers, see for example https://thispersondoesnotexist.com, as well as other data. GANs essentially work by training two neural networks simultaneously—the discriminator and the generator—to learn to reproduce variations on the training data set as well as new data. GANs have proved useful for both unsupervised learning, semi-supervised learning, fully supervised learning, and reinforcement learning.

A GAN comprises a generator and a discriminator. The generator generates samples from a prior noise distribution that is defined on input noise variables, and the discriminator is trained to determine the probability of whether a sample is from the generator or from a target distribution. The discriminator can be considered an auxiliary neural network that is used to train the generator, typically another neural network that is able to tell how much an input is “realistic”, which itself is also being updated dynamically. When training a GAN, a commonly used approach is to determine the differences between two probability distributions, e.g. by improving a generative distribution with the aim of mimicking a target distribution. Hence, a GAN can be seen as an “indirect” training of a generator using a discriminator. This implies that the generator is not trained to minimize the explicitly simulated data to a specific type of data such as an image, but rather to become indistinguishable from the training data by the discriminator. This enables the model to learn in an unsupervised manner.

### SUMMARY

Generative models are a versatile tool used in a wide variety of fields and can be implemented in different systems. Discriminative and generative models generate and sort data based on a pre-existing set of data and rules. A GAN is one type of generative model, more specifically a machine learning tool, wherein a generative neural network and a discriminator neural network are able to generate data indistinguishable from a set of data used to train both networks.

Quantum generative models take the principle of generative modelling and apply it to a quantum system with Quantum generative adversarial networks (QuGANs) as the most prominent example. The idea of QuGANs has previously been proposed theoretically and has also been implemented in a superconducting circuit and applied to distributions of eight states. Implementation of QuGAN (or some other form of machine learning) is generally possible in many hardware systems where measurements can be performed in a fast manner and where variational circuits with high expressibility can be achieved, but such solutions come with a variety of disadvantages.

The present disclosure relates to photonic quantum frequency comb system and a generative model system comprising a generator system for generating sample data, in particular a quantum generative model system comprising a generator system for generating sample quantum data, and optionally a discriminator system for distinguishing the sample (quantum) data from a training data set. The advantage of the presently disclosed generative model system is that the generator system may comprise a photonic quantum frequency comb system, configured for generating the sample data. The optional discriminator system can for example be a classical neural network, e.g. seeking to distinguish a batch of measurements from the generator from random samples of the training data set, or a simpler statistical similarity measure between the target classical distribution and the generated quantum distribution.

A photonic quantum frequency comb system as disclosed herein, which preferably is suitable for use in a generative model, may comprise a photon source, preferably a single photon source, such as an attenuated mode-locked laser, a parametric photon source or a quantum dot, configured for creating coherent single photons in equal superposition of a plurality of discrete frequency modes. Creating photons in equal superposition of different frequency modes implies that the created photons are in equal probability superposition of states. The photonic quantum frequency comb system may comprise a plurality of layers for operating the photons, wherein each layer may be configured for 1) modifying the phase and amplitude of each discrete frequency mode, and 2) mixing different discrete frequency modes. A detector can be provided for performing read-out measurements, preferably a single photon detector such as a superconducting nanowire detector.

Hence, the presently disclosed generative model approach can be seen as based on quantum optical combs creating a photon in superposition of many frequency modes. The quantum generator then generates a quantum state, whose probability distribution approximates the training probability distribution. By measuring the distribution, a classical tool, such as a similarity measure or a classical neural network, can be used as the discriminator.

By using a quantum frequency comb system, a single photon is created in a superposition of several discrete frequency modes in an equal superposition of all states. The created states can then be operated on by applying modifications on layers of Fourier-transform pulse shapers (PSs) and electro-optical modulators (EOMs), preferably in the order PS-EOM for each layer. In that case the parameters of the generator then consist of the phases of each frequency mode, controlled via the pulse shapers, while the EOM parameters are fixed, but mixes the distinct frequency modes (i.e. mixing the amplitude of each quantum states comprising each photon).

Hence, when applying the presently disclosed generative model system employing a quantum frequency comb system, the sample data may be a probability distribution of quantum states encoded in photons detected by the single-photon detector.

Simulations have shown that the presently disclosed approach with quantum frequency combs can perform multi-dimensional manipulations, which are entangling in the qubit equivalent quDit space, and require only a single detector for fast read-out. In that regard it is noted that the inherent probabilistic nature of quantum mechanics makes sampling from a learned distribution much more efficient than classical sampling. In fact, the presently disclosed approach is an example of quantum supremacy achievable in the near future. This could thus have implications in fields such as quantitative finance, optimization, quantum simulation, and quantum machine learning. Another benefit of the presently disclosed approach is that the proposed implemented scheme scales better than any possible qubit implementation in terms of required layers, cf. the example below. And in comparison to prior art quantum information technology implementations using qubits, the presently disclosed novel quantum technology platform, which features a features a large number of internal levels, so-called quDits, enables application-specific quantum advantage.

The present disclosure further relates to application of a generative model in the form of a method for generating sample data substantially indistinguishable from training data. In the preferred embodiment the method comprises the steps of
a) providing training data described by a training distribution,
b) generating a quantum state having a probability distribution by means of a quantum frequency comb system, such that the probability distribution of the quantum state approximates the training distribution,
c) measuring the probability distribution of the quantum state,
d) comparing the probability distribution with the training distribution, for example by means of either a discriminator neural network or directly through a statistical similarity measure such as log-likelihood, Jensen-Shannon divergence, Wasserstein distance, or similar measure,
e) generating a quantum state having an updated probability distribution by means of the quantum frequency comb system, based on the comparison,
f) repeat steps c)-e) until the new probability distribution is indistinguishable from the training distribution, and
g) generating sample data based on the updated probability distribution.

The discriminator can be a classical neural network seeking to distinguish measurements from the generator from random samples of the training data set. The generator and discriminator may be updated alternately in each iteration and in the end a Nash equilibrium can be obtained, where the discriminator cannot distinguish between the set of samples from the generator and the training set. Hence, a high-dimensional quantum system can be trained to produce a quantum state with statistics replicating that of a classical distribution.

### BRIEF DESCRIPTION OF THE DRAWINGS

The present disclosure will in the following be described in greater detail with reference to the accompanying drawings:

FIG. 1A shows an illustration of an example of an experimental setup of a quantum generator. A quantum frequency-comb is operated on by a series of filtering and modulation units (layers) until it is read out. The measurement of the quDit state is performed via a frequency to time mapping technique using a dispersion compensating fiber (DCF) and a superconducting nanowire single photon detector (SNSPD). A set of programmable filters in each unit enables the phase and amplitude manipulation of the frequency modes as the parameters required for the training of the generative learning approach. Electro-optic phase modulators provide the spectral mixing of the frequency modes in turn allowing for an ultimate optimal distribution of data statistics in the generation process within the frequency domain;

FIG. 1B shows a conceptual view of the experimental setup of FIG. 1A. A light source creates photons in a high-dimensional superposition of frequency modes. The photons are manipulated by layers of pulse shapers (PS) and electro-optical modulator (EOM) operations and are finally measured by a single-photon detector unit;

FIG. 2 is plot of the accuracy and Kullback-Leibler divergence as a function of training iteration during a QuGAN training session using the presently disclosed approach;

FIG. 3 is a plot of Kullback-Leibler (KL) divergence as a function of time (epochs) for a conventional GAN (blue line) and a QuGAN (orange line);

FIG. 4 is a plot of normalized counts as a function of eigenvalue size illustrating the Fisher spectrum;

FIG. 5A shows the loss of function as a function of iterations for a classical GAN. The lower figure shows the eigenvalue distribution for the real data and the created data; and

FIG. 5B shows the loss of function as a function of iterations for a Quantum GAN. The lower figure shows the eigenvalue distribution for the real data and the created data.

### DETAILED DESCRIPTION

As disclosed herein the presently disclosed approach can be based on a photonic quantum frequency comb (QFC) platform, where photons reside in a superposition of many frequency modes. The photonic state can be manipulated in the frequency domain in a quantum processing circuit and measured by a single-photon detector. The manipulations of the photons can be performed by Fourier-transform pulse shapers (PS), which enable fast and parallel manipulation of the amplitude and phase of individual frequency states, and electro-optical phase modulators (EOM), which mixes frequency modes. Both components are readily available being initially developed for telecommunications and easily implementable in a quantum system. A complete set of manipulations can be performed by layers of these two operations. Increasing the number of layers enables increased controllability of the system and improved fidelity of operations

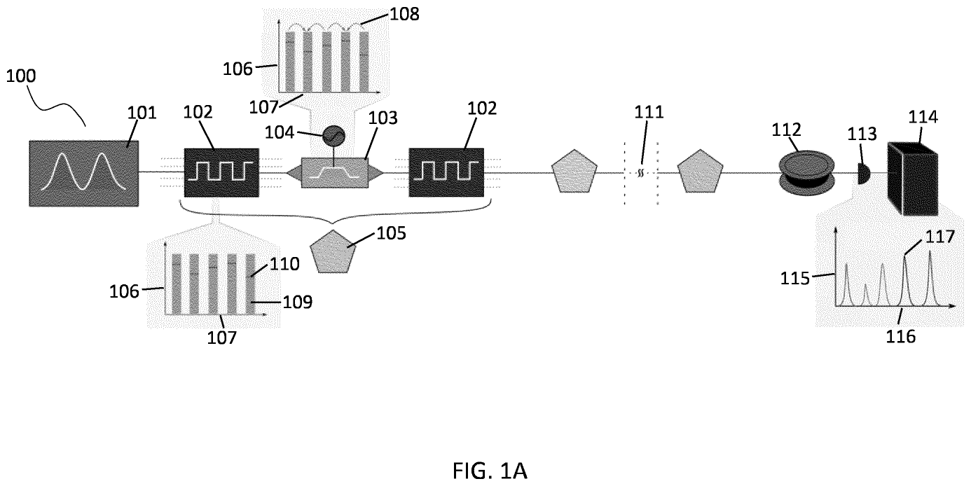

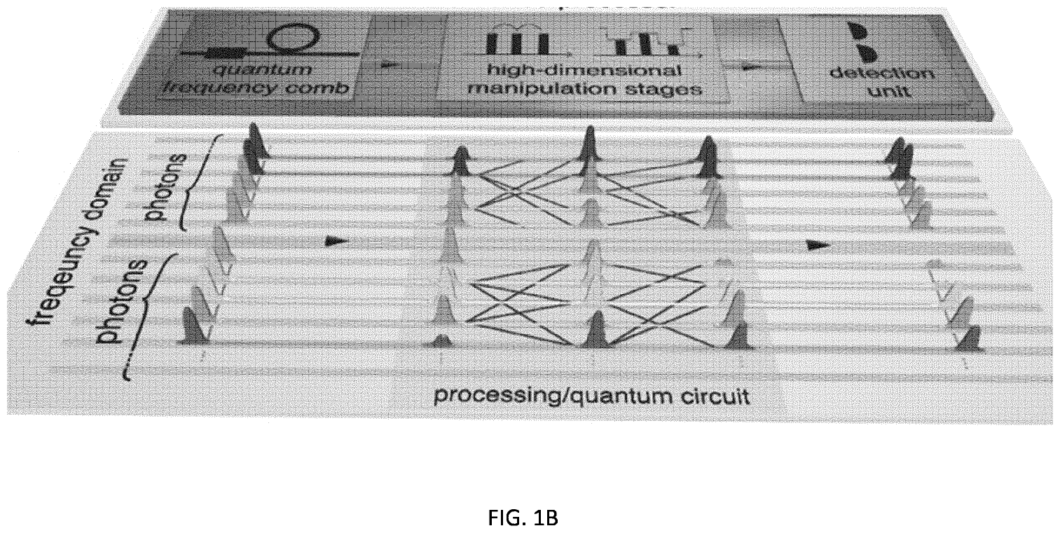

FIG. 1A shows a schematic diagram of an example of a photonic quantum frequency comb system 100 (for use in a generative model system) comprising a photon source 101, preferably a single photon source, such as a mode-locked laser, configured for creating photons in equal state superposition of a plurality of discrete frequency modes, and a plurality of layers 105 for operating the photons. Each layer may be configured for 1) modifying the phase and amplitude of each discrete frequency mode, and 2) mixing different discrete frequency modes. A detector 113 and 114 can be provided for performing read-out measurements, preferably a single photon detector. A conceptual illustration of the setup in FIG. 1A is shown in FIG. 1B

The photon source 101 is preferably a single photon source as stated above. This can be realized by for example a mode-locked laser, such as a attenuated mode-locked laser, preferably also repetition rate stabilized and synchronized to the EOM driving field. Other examples of suitable photon sources are: a mode-locked parametric photon source or a quantum dot. The photon source is preferably configured for the creation of a photon in a high-dimensional frequency superposition. The mentioned single photon sources allow the creation of highly coherent photons at a high creation rate, both properties required for the realization of the herein disclosed QuGAN.

As stated above the presently disclosed quantum frequency comb system may comprise a plurality of layers for operating the photons. Operations on the single target photon can be performed by high-fidelity telecommunication equipment which is commercially available, in particular an electro-optic phase modulator and a Fourier-transform pulse shaper. Each layer 105, shown in FIG. 1A, may comprise a combination of Fourier-transform pulse shapers 102 configured for modifying the phase and amplitude of each discrete frequency mode. The plot in FIG. 1A shows in the Y-axis 106 the amplitude 110 of each state 109 comprising a generated photon and the X-axis 107 is the frequency of each of the states comprising the generated photon. Each layer 105 may comprise at least one electro-optical (phase) modulator 103, configured for mixing different discrete frequency modes 108. The electro-optic phase modulator(s) may be fed by a radio frequency 104, preferably in the GHz frequency range, for example in a range of between 0.1 and 100 GHz, preferably between 10 and 50 GHz, preferably around 25 GHz. A plurality of layers 111 may be added to the system in order to improve the ability of manipulating the entangled photons.

Each Fourier-transform pulse shaper 102 may be configured to modify the single photon source created photons by filtering a number of discrete frequency modes, thereby defining a bandwidth for each frequency mode. This bandwidth may be on the order to at least 10, 20, or at least 30 GHz. The bandwidth provides spacing of the resulting frequency modes an integer number times the mode bandwidth frequency.

The optional single photon detector can for example be a superconducting nanowire single photon detector. The single photon detector 113, 114 can for example comprise a dispersive optical element 112, such as a length of dispersive fiber, for coupling (distinct) frequency modes to distinct temporal modes. The detector 114 measures the probability of each state, X-axis 115 in the inset plot, as a function of time, Y-axis 116 in the inset plot, comprising the manipulated photons by the previous optical layers 117.

Another examples of a suitable photonic platform for the quantum frequency comb system is the KLM photonics protocol, which is an implementation of linear optical quantum computing (LOQC), developed in 2000 Emanuel Knill, Raymond Laflamme and Gerard J. Milburn. The KLM protocol uses linear optical elements, single-photon sources and photon detectors as resources to construct a quantum computation scheme involving only ancilla resources, quantum teleportations and error corrections. The principle relies on the use of beam splitters to operate on a single photon in a superposition of several special modes. The KLM protocol can in principle implement any unitary operation, but requires a lot of overhead in terms of auxiliary photons and detectors.

The presently disclosed (quantum) generative model system can take a random distribution as an input to the parameters of the photonic system (e.g. pulse shapers). For each input the system can measure the output quantum state and take the vector of probability amplitudes as the vector output of the generator. The random input to the pulse shapers in several layers of the photonic system then allows the system to have a vector output which depends nonlinearly on a random input, i.e. equivalently to a classical neural network generator.

In case that both generator and discriminator are quantum models based on photonic platforms, this constitutes a pure quantum generative adversarial model. Hence, in a further embodiment also the discriminator system is a photonic quantum frequency comb system with the same manipulations available as in the described generative system, and the target distribution is a quantum distribution instead of a classical one.

### EXAMPLE

As stated above the presently disclosed implementation of a quantum generative model may use a quantum frequency comb system, where the generator is a single photon in a superposition of several discrete frequency modes. The photon is produced in an equal superposition of all states and is then operated on by layers of manipulation elements, more specifically Fourier-transform pulse shapers (PSs) and electro-optical modulators (EOMs) in the order PS-EOM for each layer. The parameters of the generator then consist of the amplitude and phase of each frequency mode, controlled via the pulse shapers, while the EOM parameters are controllable but fixed, but mixes the distinct frequency modes (quantum states), acting as an effective entangling gate in the multi-qubit picture.

After manipulation, the read-out is performed for each frequency with single photon detection. An example of an experimental setup implementing this trainable generator is illustrated in FIG. 1A where a pulsed mode-locked laser operating at 1550 nm wavelength, cascaded by a number of consecutive filtering (PS) and modulation units (EOM), a dispersion compensating fiber (DCF) and superconducting nanowire single photon detectors (SNSPD). Within each unit, an electro-optic phase modulator (EOM) is embedded between two programmable filters. A single radio frequency (rf) tone δ≈25 GHz is fed, through an amplifier, to the EOM. The RF-tone is locked to the repetition rate of the photon source. The first programmable wave-shaper carves out a number of frequency bins, arranged with a centre-to-centre frequency spacing of an integer multiple of the rf frequency, and with bandwidths defined preferably at the minimal capability of the programmable filters, e.g. 10-20 GHz. Within the programmable filters, the phase and amplitude of the frequency bins can be adjusted, aiming at a specific frequency mixing output. Within the EOM, each frequency component undergoes the phase modulation process whereupon a number of sidebands (depending on the modulation power and frequency) are generated at an integer multiple n of the radiofrequency tone and symmetric to the fundamental frequency component ω, that is ω±nδ. The spectral overlap between the created sidebands enables the frequency mixing between the spectral modes, in turn allowing for an optimal distribution of frequency-encoded data statistics in the generation process of the QuGAN approach. After concatenation of these basic units the photon passes through a DCF, coupling distinct frequency modes to distinct temporal modes, to the SNSPDs. The detectors will be synchronized to the repetition rate of the laser and via the use of a timing electronic, time-resolved frequency modes will be observed as outputs.

In the QuGAN example, the discriminator can be a classical neural network seeking to distinguish the batch of measurements of the generator from random samples of the training data set. The generator and discriminator are updated alternately in each iteration and in the end a Nash equilibrium is obtained, where the discriminator cannot distinguish between the set of samples from the generator and the training set, with a probability of ½. Hence, a high-dimensional quantum system is trained to produce a quantum state with statistics replicating that of a classical distribution.

Other relevant photonic technology includes the KLM photonics scheme, where beam-splitters are used to operate on a single photon in a superposition of several special modes. This scheme is likely to implement any unitary operation, but requires a lot of overhead in terms of auxiliary photons and detectors. Apart from this, there exists other solutions on the quantum computing side in everything from atomic systems to superconducting circuits and quantum dots. However, none can operate on such high-dimensional qudits as in the present case. Implementing QuGAN, or some other form of circuit learning, is possible in many systems where measurements can be performed quickly and variational circuits with high expressibility are achievable. Many of these have several disadvantages, though. For instance, KLM photonics implementations would require a large amount of photon detectors, and superconducting circuits are still limited by qubit coherence time and the fidelity of the large amount of required multi-qubit gates. In comparison, the presently disclosed approach can easily perform multi-state manipulations, which are entangling in the qubit equivalent quDit space, and requires only a single detector for fast read-out of all states.

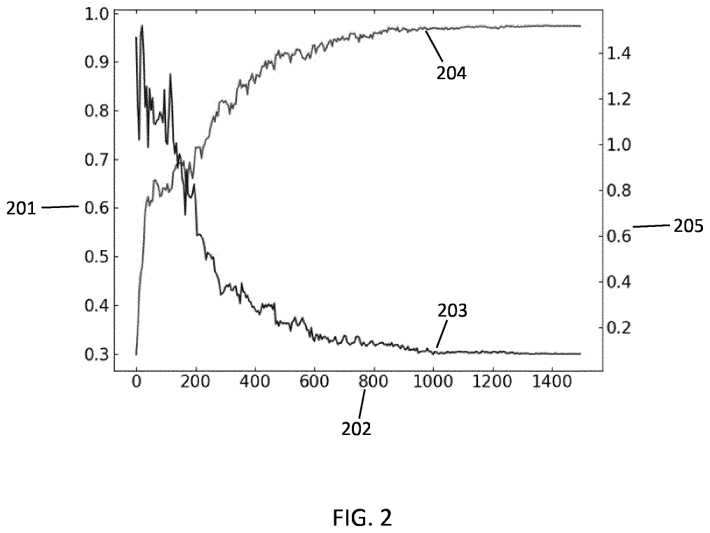

The presently disclosed approach scales better than any possible qubit implementation in terms of required layers. In initial tests it has been chosen to implement the quantum version of the bars and stripes (BAS) data set, which is traditionally a hard task for a many-state quantum system. FIG. 2 shows a plot of a simulation performed, with the left Y-axis 201 corresponding to accuracy, the right Y-axis 205 corresponding to the KL divergence and the X-axis 202 to the number of learning iterations performed to the QuGAN. The simulation, shown in FIG. 2, calculates that a system with two layers of the quantum operations in the presently disclosed photonics platform, is enough to enable the generator to learn the difficult BAS 2×3 training data set with above 97% accuracy 204 (red curve) using only two layers in comparison to the five layers used in previous implementations. A plot of the Kullback-Leibler divergence 205 (blue curve) between generated data and the BAS 2×3 dataset during a QuGAN training session employing the presently disclosed approach, shows a decay towards 0 while the accuracy approaches the value of 1 demonstrating the ability of the QuGAN to be trained relatively fast and successfully.

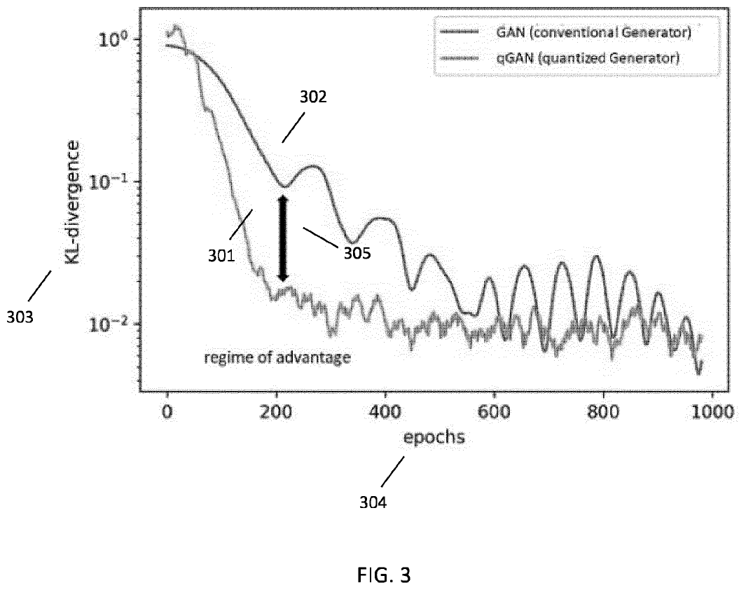

To highlight the advantage of QuGAN (as disclosed herein) in contrast to conventional GAN systems, FIG. 3 illustrates a comparison between the QuGAN (301) and other standard GAN (302). The Y-axis shows the KL convergence (303) and the X-axis shows the time (304) (in units of epochs). It is clear that QuGAN converges earlier than conventional GAN generators, as QuGAN reaches KL of an order of magnitude 10⁻² in approximately 200 epochs (305), while the standard GAN requires approximately 600 epochs to reach the same value.

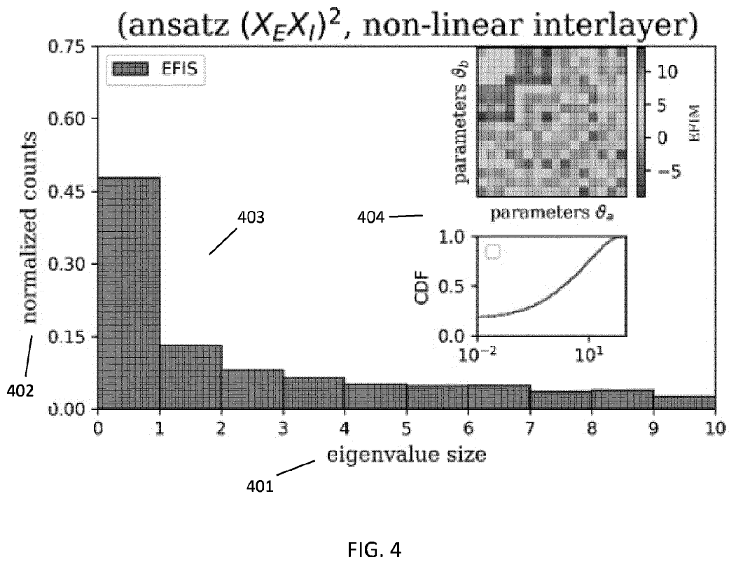

Additional proof of advantage of the QuGAN generator in view of standard GAN generators is depicted in FIG. 4 by measuring an enhanced Fisher spectrum (Fisher information matrix can be used to analyze the stability and convergence of the generator's distribution of GANs). The X-axis shows the eigenvalue size (401) and the Y-axis the normalized counts (402). The Fisher spectrum (403) shows that the GAN allows to estimate trainable parameters with fewer samples of the output distribution compared to a typical neural network of comparable size. The covariance 2D map in the inset of FIG. 4 (404) shows that the most frequent parameters are in the diagonal. This is an indication that the parameters of the generator's distribution are mostly independent of each other, which is often desirable for efficient and stable training.

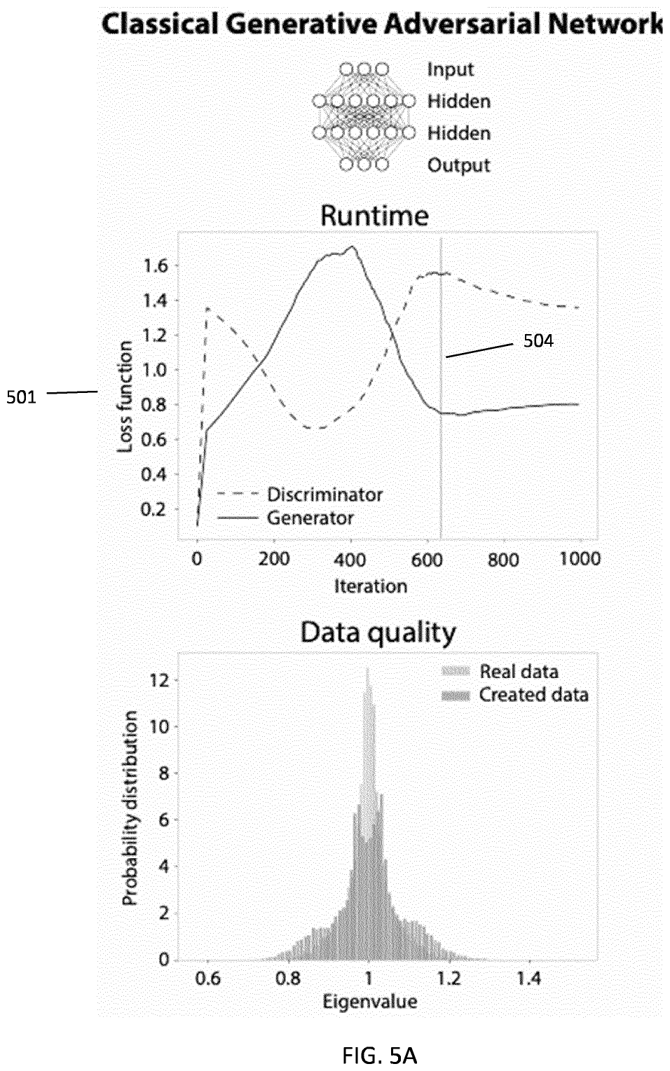

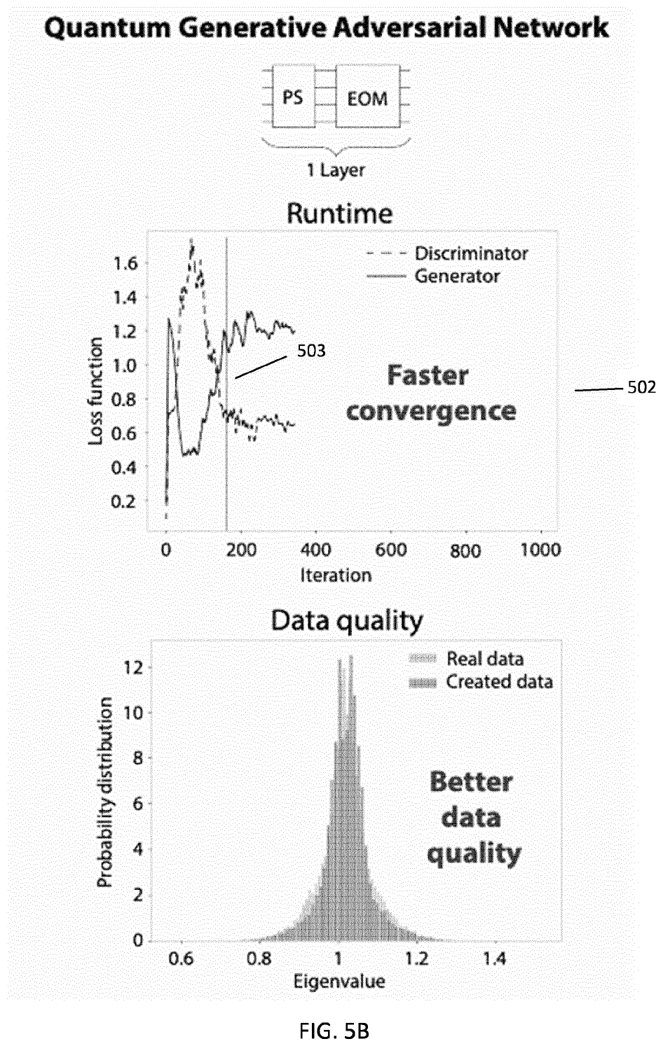

The presently disclosed approach can also be applied within finance, which is illustrated in FIGS. 5A-B. The QuGAN approach is particularly suited for the implementation in a QuDit quantum frequency comb platform and FIGS. 5A-B show results of a simulation, the generation of correlation matrices of randomly selected groups of four stocks in the S&P500 index. A recent classical GAN study of the same problem (501) points to the difficulty of this task for both financial modelling and signal processing. The results presented in FIG. 5A (501) show the performance of a classical GAN with two hidden layers and about 290 parameters. In contrast, FIG. 5B (502) shows the simulation of a hybrid system with a single D=6 quDit using 5 layers of PS and EOM operations (with 170 adjustable parameters). These results highlight that the QuGAN, as disclosed herein, requires less training epochs (503) compared to the classical GAN (504) shown in FIG. 5A, i.e. a faster training is possible. Additionally, it provides a considerably better eigenvalue distribution compared to the real S&P500 data, despite using less parameters, i.e. a much better data quality for less resources. These results clearly indicate the power of the presently disclosed quantum frequency comb-based QuGAN.

1. A photonic quantum frequency comb system, comprising
a single photon source configured for creating photons in equal state superposition of a plurality of discrete frequency modes,
a plurality of layers for operating the photons, each layer configured for
a) modifying the phase and amplitude of each discrete frequency mode, and
b) mixing different discrete frequency modes, and
a detector for performing read-out measurements.

2. The quantum frequency comb system according to claim 1, wherein the detector is a single photon detector for performing the read-out measurements.

3. The quantum frequency comb system according to claim 1, wherein the photon source is a single photon source.

4. The quantum frequency comb system according to claim 1, wherein each layer comprises one or more Fourier-transform pulse shapers configured for modifying the phase and amplitude of each discrete frequency mode.

5. The quantum frequency comb system according to claim 4, wherein each Fourier-transform pulse shaper is configured to modify the single photon source created photons by filtering a number of discrete frequency modes, defining a bandwidth for each frequency mode, and spacing the resulting frequency modes an integer number times the free spectral range.

6. The quantum frequency comb system according to claim 1, wherein each layer comprises at least one frequency mixing element, configured for mixing different discrete frequency modes.

7. The quantum frequency comb system according to claim 1, configured such that each electro-optic phase modulator is driven by frequency in the range of a radio frequency.

8. The quantum frequency comb system according to claim 1, wherein the single photon detector is a superconducting nanowire single photon detector.

9. The quantum frequency comb system according to claim 1, wherein the single photon detector comprises a dispersive optical element for coupling frequency modes to distinct temporal modes.

10. A method for generating sample data substantially indistinguishable from training data comprising the steps of:
a) providing training data described by a training distribution,
b) generating a quantum state having a probability distribution by means of a quantum frequency comb system, such that the probability distribution of the quantum state approximates the training distribution,
c) measuring the probability distribution of the quantum state,
d) comparing the probability distribution with the training distribution by means of either a discriminator neural network or directly through a statistical similarity measure,
e) generating a quantum state having an updated probability distribution by means of the quantum frequency comb system, based on the comparison,
f) repeating steps c)-e) until the updated probability distribution is indistinguishable from the training distribution, and
g) generating sample data based on the updated probability distribution.

11. A generative model system comprising 1) a quantum frequency comb system configured for generating sample data, and 2) a discriminator system for distinguishing sample data from training data, wherein the quantum frequency comb system and/or the discriminator system is/are the quantum frequency comb system of claim 1.

12. The generative model system according to claim 11, wherein the discriminator system is based on a similarity measure or a classical neural network.

13. The generative model system according to claim 11, wherein the sample data is a probability distribution of quantum states encoded in photons detected by the single-photon detector.

14. The generative model system according to claim 11, configured to execute a method for generating sample data substantially indistinguishable from training data comprising the steps of:
a) providing training data described by a training distribution,
b) generating a quantum state having a probability distribution by means of a quantum frequency comb system, such that the probability distribution of the quantum state approximates the training distribution,
c) measuring the probability distribution of the quantum state,
d) comparing the probability distribution with the training distribution by means of either a discriminator neural network or directly through a statistical similarity measure,
e) generating a quantum state having an updated probability distribution by means of the quantum frequency comb system, based on the comparison,
f) repeating steps c)-e) until the updated probability distribution is indistinguishable from the training distribution, and
g) generating sample data based on the updated probability distribution.

15. The quantum frequency comb system according to claim 3, wherein the single photon source is a mode-locked laser, a parametric photon source or a quantum dot.

16. The quantum frequency comb system according to claim 6, wherein the bandwidth for each frequency mode is in the giga-Hertz range.

17. The quantum frequency comb according to claim 1, wherein each layer comprises at least one electro-optical modulator, configured for mixing different discrete frequency modes.

18. The quantum frequency comb system according to claim 7, wherein each electro-optic phase modulator is driven by frequency in the order of 25 GHz.

19. The quantum frequency comb system according to claim 9, wherein the dispersive optical element is a dispersive fiber.

20. The method according to claim 10, wherein the statistical similarity measure is a log-likelihood, Jensen-Shannon divergence, Wasserstein distance, or similar measure.
